(19) United States
(12) Patent Application Publication
(10) Pub. No.: US 2009/0198559 A1
(43) Pub. Date: Aug. 6, 2009

(54) MULTI-RESOLUTIONAL FORECASTING SYSTEM

(75) Inventors: Yiqing Wang, Bothell, WA (US); John C. Dietz, Redmond, WA (US); Janet M. Schertzinger, Edmonds, WA (US); Adam Fritz, Seattle, WA (US)

Correspondence Address: DISNEY ENTERPRISES, INC;C/O SMITH FROHWEIN TEMPEL GREENLEE BLAHA LLC, TWO RAVINIA DRIVE, SUITE 700, ATLANTA, GA, 30346, US

(73) Assignee: Disney Enterprises, Inc., Burbank, CA (US)

(21) Appl. No.: 12/026,635

(22) Filed: Feb. 6, 2008

(51) Int. Cl. G06Q 10/00

(52) U.S. Cl. 705/10; 705/14

(57) ABSTRACT

Traffic to a selected network resource, such as a Web site, is forecast using a forecasting model that is based upon a selected resolution. The resolution can be a year, month, season, week, day of the week, an annual day-long event, or any other repetitive time interval for which data can be collected. Historical traffic data for the resolution of interest is retrieved from a database, and the selected forecasting model is applied to the retrieved data to produce a forecast.

### BACKGROUND

Inventory forecasting is a term that has been applied to predicting what will be needed to meet demand for something at a point in the future, based upon assumptions and projections from historical data. A variety of mathematical projection algorithms or models have been used for such forecasting, such as those based upon exponential smoothing, regression, and moving averages. Each of the various forecasting models can have advantages over others, depending upon the circumstances in which the particular forecasting model is used.

Cyclical and seasonal changes present special forecasting problems. Time series decomposition (and recomposition) is perhaps the most common inventory forecasting method and involves decomposing a historical time series (of collected data), extracting stationary series data, and then using adjustment factors to reintroduce cyclical and seasonal characteristics. Time series decomposition works well when there is a major stable stationary series, i.e., an interval when patterns are not changing, and only cyclical or seasonal variation from the stationary series, but does not work as well when patterns change at numerous points in time.

Inventory forecasting has been used in many fields and areas, including sales, marketing, finance and manufacturing. Such forecasting has become useful in predicting traffic to Internet Web sites or other digital network media for the purpose of selling advertising space or otherwise anticipating demand. Web site traffic is affected by various factors, rendering it difficult to predict which of the various known forecasting models would yield the most accurate forecasts for a given Web site, let alone for a given page or area of a Web site. For example, traffic patterns at a Web site relating to sports news can change not only during the a particular season (e.g., baseball season) but also during preseason, post season and holidays that occur during the season.

### SUMMARY

Embodiments of the present invention relate to a system and method for forecasting network traffic to a selected resource, such as a Web site or portion thereof, using a forecasting model that is based upon a selected resolution. The resolution can be a year, month, season, week, day of the week, an annual day-long event, or any other repetitive time interval for which data can be collected. In the context of forecasting traffic to a resource relating to, for example, sports, useful resolutions can include seasons as well as events such as game days, game weeks, playoffs, championship series and games, etc. In accordance with an exemplary embodiment of the invention, a user can select a resolution of interest from among a number of selectable resolutions, ranging from, for example, a single day, game or other event, to a season or year.

Historical traffic data is retrieved from a database. The historical traffic represents network traffic to the resource over some suitable number of units of the selected resolution. For example, if a season is selected, historical data representing network traffic to a Web site over some suitable number of seasons is retrieved. A forecast model is then selected, based upon the selected resolution, and applied to the historical data. That is, each of a number of forecasting models corresponds to or is associated with one or more of the resolutions. For example, one forecast model can be associated with a season while another forecast model can be associated with a week. If the user selects a season as the resolution, the forecast model associated with a season is applied to the historical data. If the user selects a week as the resolution, the forecast model associated with a week is applied to the historical data.

The result of applying the selected forecasting model to the historical data is a forecast of traffic for a future unit of the selected resolution, such as a week, season, etc. The result is then provided to the user. The user can use the forecast in any suitable manner or for any suitable purpose, such as determining an amount of salable advertising inventory.

Other embodiments are also provided. Other systems, methods, features, and advantages of the invention will be or become apparent to one with skill in the art to which the invention relates upon examination of the following figures and detailed description. It is intended that all such additional systems, methods, features, and advantages be included within this description, be within the scope of the invention, and be protected by the accompanying claims.

### BRIEF DESCRIPTION OF THE FIGURES

The invention can be better understood with reference to the following figures. The components within the figures are not necessarily to scale, emphasis instead being placed upon clearly illustrating the principles of the invention. Moreover, in the figures, like reference numerals designate corresponding elements throughout the different views.

FIG. 1 is a block diagram of a system for forecasting traffic to a selected Web site, in accordance with an exemplary embodiment of the invention.

FIG. 2 illustrates a number of resolutions and corresponding forecasting models, in accordance with the exemplary embodiment.

FIG. 3 is a block diagram of a computing device that is programmed or configured to effect a method for forecasting traffic to a selected Web site, in accordance with the exemplary embodiment.

FIG. 4 is a flow diagram illustrating a method for forecasting traffic to a selected Web site, in accordance with the exemplary embodiment.

### DETAILED DESCRIPTION

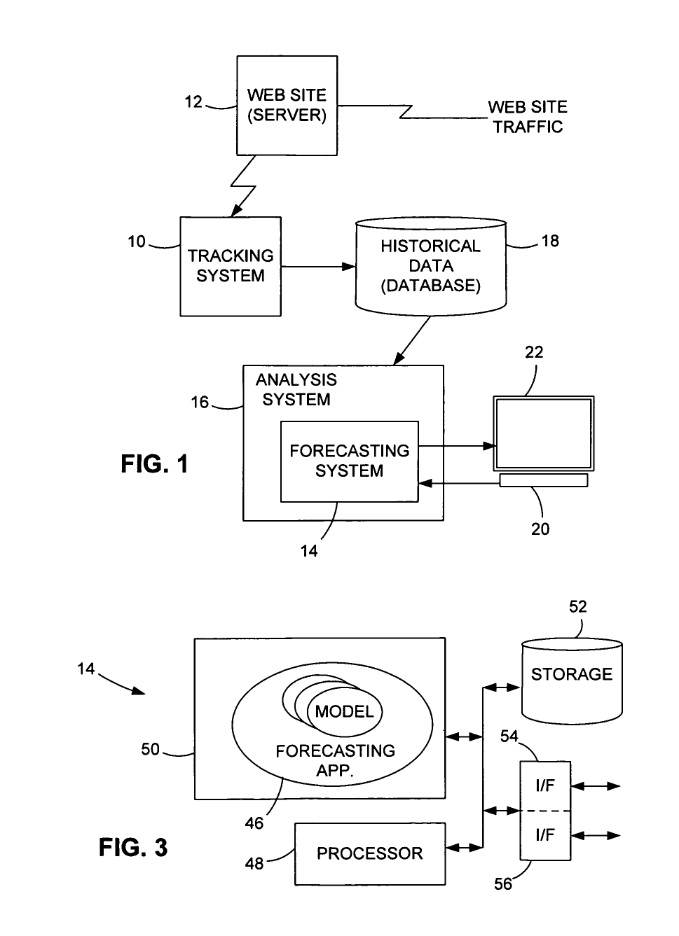

As illustrated in FIG. 1, in an illustrative or exemplary embodiment of the invention, a tracking system 10 gathers traffic information relating to the number of visits from users to one or more selected network resources, such as a Web site (i.e., hosted on a server) 12 or portion thereof. As described below, a forecasting system 14, which can be part of a more encompassing analysis system 16, can use historical traffic information gathered in this manner to forecast future traffic to Web site 12. Tracking system 10 stores such traffic information in a database 18. Such monitoring or tracking is well understood in the art and therefore not described in further detail in this patent specification (“herein”). It is sufficient to note that the traffic information stored in database 18 includes the number of visits to each selected Web site or portion thereof that occurred during any given day, month, week, year or other predetermined time interval (e.g., season). Any suitable type of Web site 12 or similar resource can be monitored or tracked in this manner, including enterprise web sites (e.g., intranet sites), and Internet aggregators.

Also, although in the exemplary embodiment of the invention the network resource is a Web site or portion thereof, in other embodiments it can be any other suitable resource of any other suitable network. For example, the resource can be an Internet Protocol television (IPTV) broadcast source or channel.

Although Web site 12 can relate to any suitable field, service, product, etc., it has been recognized in accordance with the present invention that there are difficulties associated with accurately forecasting traffic to Web site 12 that provides information about organized sports because the traffic is driven primarily by events, such as games, seasons, championships, player drafts, etc. In more traditional forecasting, such as that which is used to predict traffic to a shopping Web site, factors such as holiday seasons tend to dominate.

In the context of organized sports, a “season” is generally the portion of one year in which regulated games of the sport are in session. For example, in Major League Baseball, one season lasts approximately from April to September. In European soccer (commonly referred to in Europe as football), the season generally lasts from August until May. The term “playoff” generally refers (in certain North American professional sports in particular) to a game or series of games played after the regular season is over with the goal of determining a league champion, or a similar accolade. The term “championship” generally refers to a game or series of games played with the goal of determining which individual or team is the champion; that is, the best competitor. As the terms are used herein, they can apply to any organized sport, including baseball, basketball, football, hockey, tennis, golf and auto racing.

It has been recognized in accordance with the present invention that there is no one forecasting model that provides equally accurate results for forecasts of traffic for all of the relevant time intervals or “resolutions.” For example, while one forecasting model may provide accurate results for a traffic forecast for a day of the year, it may not provide as accurate results for a traffic forecast for a month of the year as another forecasting model. Similarly, a forecasting model that works well for forecasting Web site traffic on a weekly basis may not work as well for forecasting Web site traffic on a seasonal basis, or during or surrounding an event, such as day or series of days in which a certain annual championship game or series of games is played, or in between such events. It has been found in accordance with the present invention that, at least in certain circumstances (e.g., for certain types of Web sites such as sports information sites), the most accurate results are achieved when the forecasting model that is applied to the historical data is the optimal model for the resolution of interest.

In accordance with the invention, each of a number of forecasting models is associated with one or more resolutions. That is, for each resolution for which a user may desire to generate a forecast (e.g., a day, week, month, season, year, etc.), there is a corresponding forecasting model that is believed to work better than others for that resolution. The associations can be made in response to empirical studies or in any other suitable manner. As described below, a “zoom” feature allows the user to generate forecasts for more than one resolution, with each forecast based upon the model corresponding to the resolution. A user can interact with forecasting system 14 using suitable conventional user interface devices such as a keyboard 20, display 22, etc.

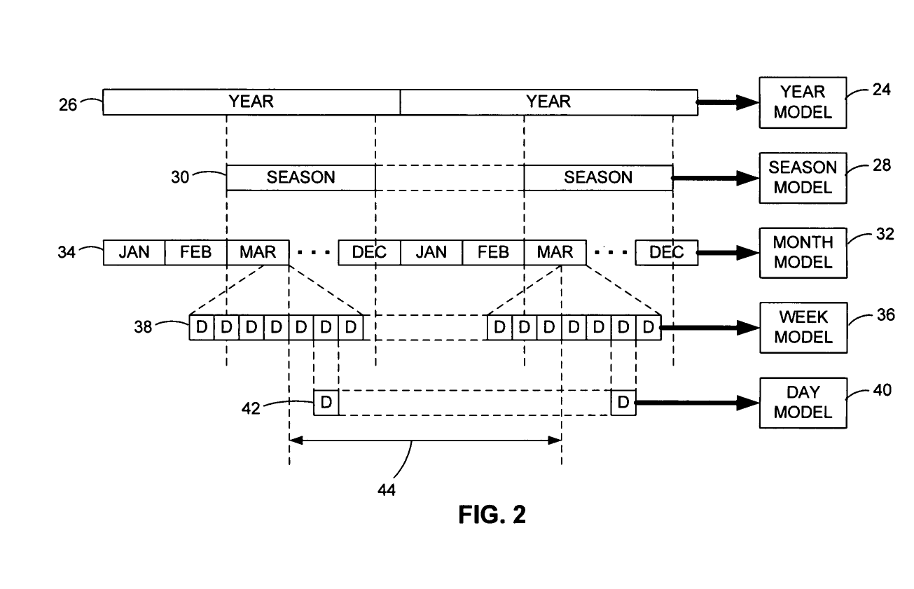

For example, as illustrated in FIG. 2, a first forecasting model 24 corresponds to a yearly forecast. In operation, as described below, model 24 receives yearly historical data 26, representing the amount of traffic to Web site 12 during those years to which data 26 correspond. Model 24 would be invoked or selected when a user desires to forecast traffic to Web site 12 during a selected year. Likewise, a second forecasting model 28 corresponds to a seasonal forecast. In operation, model 28 receives seasonal historical data 30, representing the amount of traffic to Web site 12 during the seasons to which data 30 correspond. Model 28 would be invoked or selected when a user desires to forecast traffic to Web site 12 during a selected season. Similarly, a third forecasting model 32 corresponds to a monthly forecast. In operation, model 32 receives monthly historical data 34, representing the amount of traffic to Web site 12 during the months to which data 34 correspond. Model 32 would be invoked or selected when a user desires to forecast traffic to Web site 12 during a selected month. A fourth forecasting model 36 corresponds to a weekly forecast. In operation, model 36 receives weekly historical data comprising data 38, representing the amount of traffic to Web site 12 during those weeks (i.e., seven-day intervals) to which data 38 correspond. Model 36 would be invoked or selected when a user desires to forecast traffic to Web site 12 during a selected week of the year. For example, a user may desire to forecast traffic during a week in which a certain championship game or series of games is played annually. A fifth forecasting model 40 corresponds to a daily forecast. In operation, model 40 receives daily historical data comprising data 42, representing the amount of traffic to Web site 12 during those days to which data 42 correspond. Model 40 would be invoked or selected when a user desires to forecast traffic to Web site 12 during a selected day of the year. For example, a user may desire to forecast traffic during a day on which a championship game is played every year. The resolutions described above are intended only as examples, and others will occur to persons skilled in the art to which the invention relates in view of these teachings. For example, another resolution could be the time interval between the weeks in which a certain championship game or series of games is played annually, as indicated by the arrow 44, or a pre-season, post-season, or off-season interval.

As illustrated in FIG. 3, forecasting system 14 can be implemented in a general-purpose computer that is programmed with a forecasting software application program 46. Although shown as a stand-alone computer for purposes of clarity, the same principles apply in a client-server environment in which a user uses a client computer to interact with a server computer. In accordance with conventional computing principles, a processor 48 acts upon forecasting software application program 46 to effect the methods of the invention described herein. Although forecasting software application program 46 is conceptually shown for purposes of illustration as stored in or residing in a memory 50, persons of skill in the art can appreciate that such software may not in actuality reside in its entirety in memory 50 but rather may be retrieved in portions on an as-needed basis from a local source such as a storage device 52 (e.g., a local magnetic disk) or a remote source via a network interface 54. Forecasting system 14 can also access database 18 (FIG. 1) via network interface 54. Other interfaces 56 couple forecasting system 14 to display 22, keyboard 20, etc. (FIG. 1). Persons of skill in the art will readily be capable of programming or otherwise configuring forecasting system 14 to perform the methods of the invention in view of the teachings herein.

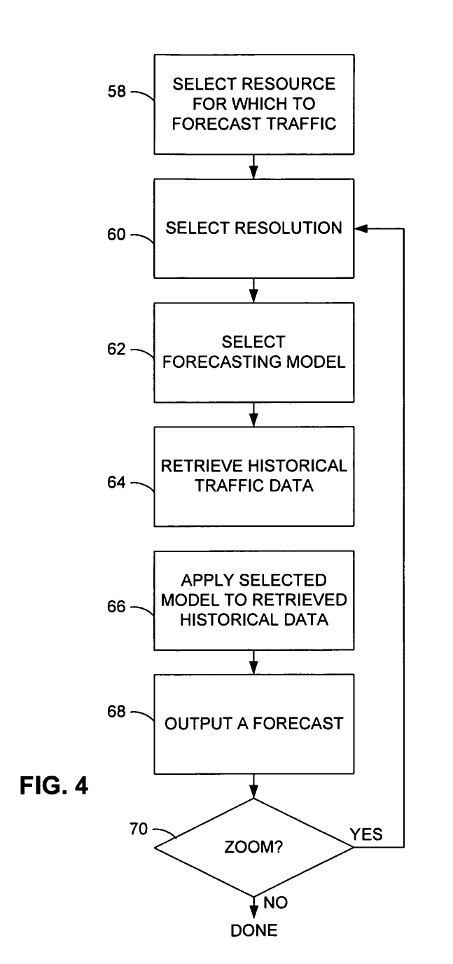

As illustrated in FIG. 4, an exemplary method begins with a step 58 of selecting a network resource for which it is desired to forecast traffic. The selection can be pre-performed, such that the user has no control over it, or the user can be presented with choices or options from which the user can select. It is contemplated that not only a Web site 12 can be selected but also portions of Web site 12, such as a specific page, or even specific features on a page with which a user can interact, such as an advertisement located on an area of a page. The advertisement can be interactive, such that it performs functions in response to user input.

At step 60, the user selects a resolution. As described above, the user can select a year, season, month, week, day, event, hour-of-day (time), or any other suitable resolution at which it is desired to generate a forecast. Although in the exemplary embodiment of the invention the user initiates this step, in other embodiments it can be initiated in any other suitable manner, such as in an automated matter as one of several resolutions for which forecasts are to be generated sequentially or in parallel.

At step 62, a forecasting model corresponding to the selected resolution is selected from among the various available forecasting models. Forecasting software application 46 (FIG. 3) can include not only the code that effects the general methods described herein but also the models themselves and a table or other data structure (not shown) that relates the models to the resolutions. Such a table can be used to look up the corresponding model for any selected resolution. The forecasting models from which a selection can be made can include any known in the art or that would occur to persons skilled in the art, including, for example: time series decomposition; exponential smoothing; regression; moving average; Auto-Regressive Integrated Moving Average (ARIMA); and day-of-week. (A “day-of-week” model refers to taking the distribution of total traffic in a specific week and applying the distribution to the forecasted week and the predicted total weekly traffic volume to predict traffic on a specific day of the week, e.g., Saturdays.) A table can be constructed on any suitable basis, such as on the basis of an expert's judgment or empirical data as to which forecasting model would provide the most accurate results for which resolutions. A feature can be included to allow the user to select a forecasting model or select the associations, so as to override any such automatic or default associations based upon a predetermined table.

At step 64, historical traffic data for the selected resource for some suitable number of units (e.g., days, months, years, etc.) of data of the selected resolution are retrieved from database 18 (FIG. 1). For example, if it is desired to generate a forecast for the coming year, historical traffic data for the past, for example, five years, can be retrieved or selected. The number of units of historical data retrieved depends upon factors with which persons skilled in the art are familiar, including the amount of data available (i.e., stored in database 18) and the amount of data needed to produce an accurate result using the selected model. As such considerations are well understood by persons skilled in the art, they are not discussed in further detail herein.

At step 66, the selected model is applied to the retrieved historical data to produce a result representing a forecast of the traffic to Web site 12 or portion thereof during the selected time interval. At step 68, the result is output via the user interface (e.g., display 22) for the user to use in any desired manner. For example, the user can use the forecast to determine an amount of salable advertising inventory.

A “zoom” feature allows the user to select a different resolution, as indicated by step 70. For example, if the user has selected a year resolution and generated a forecast for traffic, for example, during the coming year, the user can then select a week during the year and generate a forecast for traffic during that week. As described above, the model that is used to generate the forecast for traffic during the selected year can be different from the model used to generate the forecast for traffic during the selected month. The user can continue zooming by selecting a still higher resolution, such as a day of that week. Accordingly, a still different model can be used to generate a forecast for traffic on the selected day. From a forecast for traffic on the selected day, the user can continue to zoom by selecting an hour of the day (or other intra-day time interval).

When the user is finished generating forecasts (e.g., following deciding whether to zoom at step 70), no additional steps need be performed.

As described above, the invention can be used in conjunction with other analysis tools (of analysis system 16 in FIG. 1). For example, a user can generate forecasts in accordance with the present invention as well as use tools for analyzing advertising inventory relating to Web site 12 or other such resource.

While one or more embodiments of the invention have been described as illustrative of or examples of the invention, it will be apparent to those of ordinary skill in the art that other embodiments and implementations are possible that are within the scope of the invention. For example, although the exemplary embodiment relates to forecasting user traffic on a Web site, in other embodiments the invention can relate to forecasting user traffic on an Internet Protocol television channel. Accordingly, the scope of the invention is not to be limited by such embodiments but rather is determined by the appended claims.

What is claimed is:

1. A method for forecasting network traffic to a selected resource, comprising:
selecting a resource available to users of an electronic network;
selecting a resolution from a plurality of selectable resolutions ranging from a highest resolution to a lowest resolution;
selecting a forecasting model corresponding to the resolution from a plurality of selectable forecasting models, each corresponding to at least one resolution;
retrieving historical traffic data for the selected resource from a database, the historical data representing network traffic over a plurality of units of the selected resolution;
applying the selected forecasting model to the historical traffic data to forecast traffic for a future unit of the selected resolution; and
outputting a traffic forecast.

2. The method claimed in claim 1, further comprising:
following the step of outputting a traffic forecast, selecting a higher resolution;
selecting a second forecasting model corresponding to the higher resolution from the plurality of selectable forecasting models;
retrieving additional historical traffic data from a database, the additional historical data representing network traffic over a plurality of units of the selected higher resolution;
applying the second forecasting model to the additional historical traffic data to forecast traffic for a future unit of the selected higher resolution; and
outputting a traffic forecast on an electronic user interface device.

3. The method claimed in claim 1, wherein the step of selecting a resource available to users of an electronic network comprises selecting a Web site.

4. The method claimed in claim 3, wherein the step of selecting a resource available to users of an electronic network comprises selecting a sub-area of a Web site.

5. The method claimed in claim 3, wherein the sub-area is an advertisement.

6. The method claimed in claim 4, wherein the advertisement is interactive.

7. The method claimed in claim 1, wherein the step of selecting a forecasting model corresponding to the resolution from a plurality of selectable forecasting models comprises selecting a forecasting model from the group consisting of: time series decomposition; exponential smoothing; regression; moving average; Auto-Regressive Integrated Moving Average (ARIMA); and day-of-week.

8. The method claimed in claim 1, wherein the step of selecting a resolution from a plurality of selectable resolutions comprises selecting a resolution from the group consisting of: year; season; month; week; day; hour-of-day; event.

9. The method claimed in claim 8, wherein the season relates to an organized sport season.

10. The method claimed in claim 9, wherein the season is selected from the group consisting of: pre-season; regular season; post-season and off-season.

11. The method claimed in claim 8, wherein event relates to an organized sport event.

12. The method claimed in claim 11, wherein the event is selected from the group consisting of: championship game day; championship game week; playoff day; and
playoff week.

13. A system for forecasting network traffic to a selected resource, the system comprising a processing system programmed or configured to:
select a resource available to users of an electronic network;
select a resolution from a plurality of selectable resolutions ranging from a highest resolution to a lowest resolution;
select a forecasting model corresponding to the resolution from a plurality of selectable forecasting models, each corresponding to at least one resolution;
retrieve historical traffic data for the selected resource from a database, the historical data representing network traffic over a plurality of units of the selected resolution;
apply the selected forecasting model to the historical traffic data to forecast traffic for a future unit of the selected resolution; and
output a traffic forecast.

14. The system claimed in claim 13, wherein the processing system is further programmed or configured to:
following the step of outputting a traffic forecast, select a higher resolution;
select a second forecasting model corresponding to the higher resolution from the plurality of selectable forecasting models;
retrieve additional historical traffic data from a database, the additional historical data representing network traffic over a plurality of units of the selected higher resolution;
apply the second forecasting model to the additional historical traffic data to forecast traffic for a future unit of the selected higher resolution; and
output a traffic forecast on an electronic user interface device.

15. The system claimed in claim 13, wherein the processing system is programmed or configured to select a resource available to users of an electronic network by being programmed or configured to select a Web site.

16. The system claimed in claim 15, wherein the processing system is programmed or configured to select a resource available to users of an electronic network by being programmed or configured to select a sub-area of a Web site.

17. The system claimed in claim 16, wherein the sub-area is an advertisement.

18. The system claimed in claim 17, wherein the advertisement is interactive.

19. The system claimed in claim 13, wherein the wherein the processing system is programmed or configured to select a forecasting model corresponding to the resolution from a plurality of selectable forecasting models by being programmed or configured to select a forecasting model from the group consisting of: time series decomposition; exponential smoothing; regression; moving average; Auto-Regressive Integrated Moving Average (ARIMA); and day-of-week.

20. The system claimed in claim 13, wherein the processing system is programmed or configured to select a resolution from a plurality of selectable resolutions by being programmed or configured to select a resolution from the group consisting of: year; season; month; week; day; hour-of-day; event.

21. The system claimed in claim 20, wherein the season relates to an organized sport season.

22. The system claimed in claim 21, wherein the season is selected from the group consisting of: pre-season; regular season; post-season and off-season.

23. The system claimed in claim 20, wherein event relates to an organized sport event.

24. The system claimed in claim 23, wherein the event is selected from the group consisting of: championship game day; championship game week; playoff day; and playoff week.

25. A system for forecasting network traffic to a selected resource, comprising:
a user interface;
a network interface; and
a processing system programmed or configured to:
select a resource available to users of an electronic network;
select a resolution from a plurality of selectable resolutions ranging from a highest resolution to a lowest resolution;
select a forecasting model corresponding to the resolution from a plurality of selectable forecasting models, each corresponding to at least one resolution;
retrieve historical traffic data for the selected resource from a database, the historical data representing network traffic over a plurality of units of the selected resolution;
apply the selected forecasting model to the historical traffic data to forecast traffic for a future unit of the selected resolution; and
output a traffic forecast.
